(19) United States
(12) Patent Application Publication
(10) Pub. No.: US 2019/0124949 A1
(43) Pub. Date: May 2, 2019

(54) READY-MIXED COMPOUND FEED CONCENTRATES AND METHOD OF PREPARING THE SAME

(71) Applicants: Hamidreza Ghalamkari, Isfahan (IR); MOHAMMADREZA GHALAMKARI, Isfahan (IR)

(72) Inventors: Hamidreza Ghalamkari, Isfahan (IR); MOHAMMADREZA GHALAMKARI, Isfahan (IR)

(73) Assignee: SEPAHAN DANEH PARSIAN CO, Isfahan, OT (IR)

(21) Appl. No.: 15/588,600

(22) PCT Filed: Dec. 17, 2015
(86) PCT No.: PCT/IB2015/059750

§ 371 Date: May 6, 2017

(51) Int. Cl. A23K 10/30; A23K 10/22; A23K 20/24; A23K 20/26; A23K 20/174; A23K 20/195

(52) U.S. Cl. CPC A23K 10/30; A23K 10/22; A23K 20/195; A23K 20/26; A23K 20/174; A23K 20/24

(57) ABSTRACT

The embodiments herein relate to a ready-mixed feed concentrate composition and a method of preparing the same. The ready-mixed compound feed concentrate, comprises a feed concentrate composition and a premix feed concentrate composition. The premix feed concentrate composition is present in an amount selected from the group consisting of 5%, 10%, 15%, 20%, 25% and 50%. The method of preparing a ready-mix compound feed concentrate comprises mixing a predetermined quantity of a feed concentrate composition, and adding a predetermined quantity of a premix feed concentrate composition. The predetermined quantity of a premix feed concentrate composition is selected from the group consisting of 5%, 10%, 15%, 20%, 25% and 50%.

### BACKGROUND

### Technical Field of Invention

The embodiments herein generally relate to livestock feed compositions and particularly to feed concentrate compositions for livestock. The embodiments herein more particularly relate to a ready-mixed compound feed concentrate that requires an easy management and reduced calculations for the preparation of the final livestock feeds.

### Description of Related Art

Livestock feeds provide the basic nutrients required for animal production, including energy, proteins and amino acids (macro-nutrients), and minerals, vitamins and other micro-nutrients. Feeds may be broadly classified as concentrates and roughages, depending on their composition. Concentrates are feeds that contain a high density of nutrients, usually low in crude fibre content (less than 18% of dry matter (DM)) and high in total digestible nutrients. Roughages are feeds with a low density of nutrients, with a crude fibre content over 18% of DM, including most fresh and dried forages and fodders. The definitions of these feeds and their nutrient contents vary somewhat in the literatures. Concentrates may be fed in raw or milled forms as individual feeds (sometimes referred to as straights), or may be blended or formulated into balanced rations for particular production purposes (compound feeds). Compound feeds may be mixed on-farm but are also produced by the commercial feed compounding industry.

Animal feed is composed of grain and energy ingredients such as barely, corn, and fat powder, protein sources such as plant protein sources like soybean meal, soybean, rapeseed meal and animal protein sources such as fish meal, vitamin supplements such as fat soluble vitamins (A, D3, E, K) and water-soluble vitamins (C, B complex) and mineral supplements (containing micronutrients and macronutrients such as calcium, phosphorus, sodium, chloride, magnesium, potassium, sulfur, iron, copper, zinc, iodine, selenium, chromium, cobalt and manganese) as well as additives used in animal feed (salt, sodium bicarbonate, calcium carbonate, magnesium oxide, dicalcium phosphate, monensin and toxins binder) extrusion. These ingredients supply the needed energy and nutrients to the animal such as carbohydrate, protein, fat, minerals and vitamins. There is a need for the supply of the animal nutritional requirement at a standard level. Moreover, in the farms there is a requirement of a high productive and reproductive performance.

Advances in the genetic improvements have enhanced animal production potentials which can be translated into actual production if improved feed rations are made available to them. This is especially important because the achievement of the enhanced production and reproduction in animal industry naturally leads to reliable resources for meeting national requirements for protein and dairy products and also to food security without the need for any greater animal population which is now available. Moreover, the enhanced digestibility and absorbability of the available feed ingredients in the ruminants decreases the needs to imports for corn, barley, soybean meal, rapeseed meal, etc.

Given the fact that most farmers fail to adopt or follow a scientifically justified plan for procuring feed concentrates, especially with regard to the micronutrient (vitamins, minerals, feed additives) content. They cannot ensure a uniform and desirable purity of their raw ingredients since the compound concentrates might have been supplied, beyond the farmer's control, from different resources with different qualities. In addition to its financial risks and losses, this procurement plan causes the decrease of productive and reproductive performance due to daily changes in the animal ration, and finally it causes of in force to cull from the herd. Moreover, as the per capita dose of such ingredients in the ration is low (for example, Monensin in each ton of the concentrate is only about 200 grams), so the labour errors in the absence of accurate scales and measuring tools are high and there is always a weight measurement error percentage which causes imbalances in the ration. Finally, a large amount of each ingredient (which might reach 5 to 10%) might be wasted due to different kind of reason which becomes costly for farmers.

In order to overcome the problems associated with varying purity levels of raw ingredients used in compound concentrates, all the important ingredients of the ration such as calcium carbonate, di-calcium phosphate, magnesium oxide, salt, sodium bicarbonate, toxin binders, and mineral supplements (including iron, copper, zinc, manganese, cobalt, etc.) vitamin supplements and other feed additives need to be analysed periodically to determine the purity level of their effective elements. The data can then be used to develop formulations that are regularly revised in accordance with new analyses so that the animal needs are adequately met.

It has been a long standing practice in the livestock breeding industry to use 100% (complete) feed concentrates prepared by either the traditional or the industrial method. In both these methods, over 20 different nutrient ingredients including barely, corn, soybean meal, canola meal, cottonseed meal, fish meal, fat powder, calcium carbonate, Di calcium phosphate, salt, sodium bicarbonate, magnesium oxide, toxin binder, monensin, probiotics, vitamin supplements (A, D3, E), and mineral supplements (Zn, Cu, Co, Fe, Se, I, and Mn) are procured and mixed. Obviously, the lower the percentage weight of a material in the complete concentrate, the higher the error in its weight measurement. For instance, as little as 200 g (0.2 kilogram) of monensin should be added to each ton of complete compound concentrate but it is commonly observed that its measurement errors are far greater than those for materials of higher proportions of, say, 100 kg/ton. Overall, the industrial method of producing feed concentrates has failed to win customer recognition and satisfaction due to lack of trust by farmers in the quality of the feed ingredients (e.g., grains and oil seed meals) while the traditional method has not been efficient mainly due to the differences in the proportions of the nutrients in the primary raw material, lack of formulation based on the real needs of the animal and failure to observe the required purity and proportions of the raw materials, unavailability of the required infrastructure and precise measuring instruments, excessive use of micronutrients common in different feed sources, and poor knowledge and understanding by practitioners and their lack of access to scientific resources. The personal, rather than scientifically-based, preferences in the decision-making process; and great diversity and lack of proportionality in the composition and distribution of micronutrients in each mixer that ultimately leads to failure to provide adequate supply of ingredients required for healthy livestock production and maintenance. The above observations and considerations warrant provisions for preparing premixed feed concentrates of up to 50 percent aimed at providing adequate supplements for the commercially available feed concentrates.

The traditional feed ingredients constituting animal feed concentrate comprises 26% of ground barley, 25% of ground corn, 20% of soybean meal, 5% of rapeseed meal, 5% of extruded soybeans, 5% of cotton seeds, 3% of corn gluten meal, 3% of fish meal, 2.5% of protected fat meal, 1-4% of sodium bicarbonate, 0.4% of magnesium oxide, 1.3% of calcium carbonate, 0.5% of dicalcium phosphate, 0.5% of salt and 1.4% of vitamin and mineral supplements. While preparing a final feed concentrate, the farmers usually miss some ingredient or add in more or lesser value which is actually required.

Hence there is a need to develop the premixed concentrates with various measures up to atleast 50 percent to enable the farmers avoid the above mentioned errors in the measurement of the right amount of feed and its ingredients. There is a need to develop premixed concentrations with precise quantities calculated primarily to avoid any material wastage and nutrient loss while preparing the final animal rations.

The above mentioned shortcomings, disadvantages and problems are addressed herein, as detailed below.

### SUMMARY OF THE INVENTION

The primary object of the embodiments herein is to provide a premixed concentrate composition for the livestock and a method of preparing a premixed concentrate compositions and various other compositions in varying percentages up to at least 50 percent, wherein the compositions are altered based on a predetermined amount thus reducing the time involved in the accurate measurements of the micronutrients while preparing.

Another object of the embodiments herein is to provide a premixed concentrate compositions and method of preparing the same wherein the method enables the farmers to avoid the measurement errors and material wastages occurring due to the failure to set the right purity and proportions, imprecise weight measurement.

Yet another object of the embodiments herein is to provide premixed concentrate compositions and method of preparing the same wherein the method provides a controlled feed concentrates for reliable use in animal rations.

Yet another object of the embodiments herein is to provide a predetermined premixed feed ingredient table showing the different livestock groups to achieve the best animal performance in terms of production and reproduction as well as maintaining the best animal health.

Yet another object of the embodiments herein is to provide a route for calculating the most proper proportions of all the major raw materials used in a feed concentrate and to provide a steady and uniform concentrate that is practically free from any labour errors.

The various embodiments herein provide a ready-mixed feed concentrate composition and a method of preparing the same.

According to one embodiment herein, a ready-mixed compound feed concentrate, comprises a feed concentrate composition and a premix feed concentrate composition. The premix feed concentrate composition is present in an amount selected from the group consisting of 5%, 10%, 15%, 20%, 25% and 50%.

According to an embodiment herein, the ready-mixed compound feed concentrate comprises:
a feed concentrate composition; and
a 5% premix feed concentrate composition, wherein said feed concentrate composition comprises:
   barley—25%,
   corn—28.8%,
   soybean meal—17.4%,
   canola meal—6.38%,
   whole soybean—8%,
   fishmeal—4%,
   fat powder—3%,
   sodium bicarbonate—1.3%, and
   salt—0.5%;
wherein said 5% premix feed concentrate composition comprises:
   magnesium oxide—0.3%,
   calcium carbonate—1.4%,
   di calcium phosphate—0.5%,
   toxin binder—0.2%,
   monensin—0.02%,
   vitamin supplements—0.7%, and
   minerals supplements—0.7%.

According to an embodiment herein, the ready-mixed compound feed concentrate comprises:
a feed concentrate composition; and
a 10% premix feed concentrate composition, wherein said feed concentrate composition comprises:
   barley—25%,
   corn—27%,
   soybean meal—16.72%,
   canola meal—6.38%,
   whole soybean—8%,
   fishmeal—4%, and
   fat powder—3%;
wherein said 10% premix feed concentrate composition comprises:
   sodium bicarbonate—1.3%,
   salt—0.5%
   magnesium oxide—0.3%,
   calcium carbonate—1.4%,
   di calcium phosphate—0.5%,
   toxin binder—0.2%,
   monensin—0.02%,
   vitamin supplements—0.7%, and
   minerals supplements—0.7%.

According to an embodiment herein, the ready-mixed compound feed concentrate comprises:
a feed concentrate composition; and
a 15% premix feed concentrate composition, wherein said feed concentrate composition comprises:
   barley—25%,
   corn—26.1%,
   soybean meal—16.3%,
   canola meal—6.38%,
   whole soybean—8%, and
   fishmeal—4%;
wherein said 15% premix feed concentrate composition comprises:
   fat powder—3%
   sodium bicarbonate—1.3%,
   salt—0.5%
   magnesium oxide—0.3%,
   calcium carbonate—1.4%,
   di calcium phosphate—0.5%,
   toxin binder—0.2%,
   monensin—0.02%,
   vitamin supplements—0.7%, and
   minerals supplements—0.7%.

According to an embodiment herein, the ready-mixed compound feed concentrate comprises:
a feed concentrate composition; and
a 20% premix feed concentrate composition, wherein said feed concentrate composition comprises:
   barley—25%,
   corn—25.4%,
   soybean meal—16%,
   canola meal—6.38%,
   whole soybean—8%; and
wherein said 20% premix feed concentrate composition comprises:
   fishmeal—4%,
   fat powder—3%,
   sodium bicarbonate—1.3%,
   salt—0.5%,
   magnesium oxide—0.3%,
   calcium carbonate—1.4%,
   di calcium phosphate—0.5%,
   toxin binder—0.2%,
   monensin—0.02%,
   vitamin supplements—0.7%, and
   minerals supplements—0.7%.

According to an embodiment herein, the ready-mixed compound feed concentrate comprises:
a feed concentrate composition; and
a 25% premix feed concentrate composition, wherein said feed concentrate composition comprises:
   barley—25%,
   corn—27.5%,
   soybean meal—17%,
   canola meal—6.38%,
wherein said 25% premix feed concentrate composition comprises:
   whole soybean—8%,
   fishmeal—4%,
   fat powder—3%,
   sodium bicarbonate—1.3%,
   salt—0.5%,
   magnesium oxide—0.3%,
   calcium carbonate—1.4%,
   di calcium phosphate—0.5%,
   toxin binder—0.2%,
   monensin—0.02%,
   vitamin supplements—0.7%, and
   minerals supplements—0.7%.

According to an embodiment herein, the ready-mixed compound feed concentrate comprises:
a feed concentrate composition; and a 50% premix feed concentrate composition, wherein said feed concentrate composition comprises:
   barley—25%,
   corn—25%,
wherein said 50% premix feed concentrate composition comprises:
   soybean meal—17%,
   canola meal—6.38%,
   whole soybean—8%,
   fishmeal—4%,
   fat powder—3%,
   sodium bicarbonate—1.3%,
   salt—0.5%,
   magnesium oxide—0.3%,
   calcium carbonate—1.4%,
   di calcium phosphate—0.5%,
   toxin binder—0.2%,
   monensin—0.02%,
   vitamin supplements—0.7%, and
   minerals supplements—0.7%.

According to another embodiment herein, a method of preparing a ready-mix compound feed concentrate comprises mixing a predetermined quantity of a feed concentrate composition, and adding a predetermined quantity of a premix feed concentrate composition. The predetermined quantity of a premix feed concentrate composition is selected from the group consisting of 5%, 10%, 15%, 20%, 25% and 50%.

According to an embodiment herein, the ready-mix compound feed concentrate comprising 5% premix feed concentrate composition is prepared by adding:
barley—25%,
corn—28.8%,
soybean meal—17.4%,
canola meal—6.38%,
whole soybean—8%,
fishmeal—4%,
fat powder—3%,
sodium bicarbonate—1.3%, and
salt—0.5%; wherein said 5% premix feed concentrate composition is prepared by adding:
magnesium oxide—0.3%,
calcium carbonate—1.4%,
di calcium phosphate—0.5%,
toxin binder—0.2%,
monensin—0.02%,
vitamin supplements—0.7%, and
minerals supplements—0.7%.

According to an embodiment herein, the ready-mix compound feed concentrate comprising 10% premix feed concentrate composition is prepared by adding:
barley—25%,
corn—27%,
soybean meal—16.72%,
canola meal—6.38%,
whole soybean—8%,
fishmeal—4%, and
fat powder—3%;
wherein said 10% premix feed concentrate composition is prepared by adding:
sodium bicarbonate—1.3%,
salt—0.5%
magnesium oxide—0.3%,
calcium carbonate—1.4%,
di calcium phosphate—0.5%,
toxin binder—0.2%,
monensin—0.02%,
vitamin supplements—0.7%, and
minerals supplements—0.7%.

According to an embodiment herein, the ready-mix compound feed concentrate comprising 15% premix feed concentrate composition is prepared by adding:
barley—25%,
corn—26.1%,
soybean meal—16.3%,
canola meal—6.38%,
whole soybean—8%, and
fishmeal—4%;
wherein the 15% premix feed concentrate composition is prepared by adding:
fat powder—3%
sodium bicarbonate—1.3%,
salt—0.5%
magnesium oxide—0.3%,
calcium carbonate—1.4%,
di calcium phosphate—0.5%,
toxin binder—0.2%,
monensin—0.02%,
vitamin supplements—0.7%, and
minerals supplements—0.7%.

According to an embodiment herein, the ready-mix compound feed concentrate comprising 20% premix feed concentrate composition is prepared by adding:
barley—25%,
corn—25.4%,
soybean meal—16%,
canola meal—6.38%,
whole soybean—8%; and
wherein the 20% premix feed concentrate composition is prepared by adding:
fishmeal—4%,
fat powder—3%,
sodium bicarbonate—1.3%,
salt—0.5%,
magnesium oxide—0.3%,
calcium carbonate—1.4%,
di calcium phosphate—0.5%,
toxin binder—0.2%,
monensin—0.02%,
vitamin supplements—0.7%, and
minerals supplements—0.7%.

According to an embodiment herein, the ready-mix compound feed concentrate comprising 25% premix feed concentrate composition is prepared by adding:
barley—25%,
corn—27.5%,
soybean meal—17%,
canola meal—6.38%,
wherein the 25% premix feed concentrate composition is prepared by adding:
whole soybean—8%,
fishmeal—4%,
fat powder—3%,
sodium bicarbonate—1.3%,
salt—0.5%,
magnesium oxide—0.3%,
calcium carbonate—1.4%,
di calcium phosphate—0.5%,
toxin binder—0.2%,
monensin—0.02%,
vitamin supplements—0.7%, and
minerals supplements—0.7%.

According to an embodiment herein, the ready-mix compound feed concentrate comprising 50% premix feed concentrate composition is prepared by adding:
barley—25%, and
corn—25%,
wherein the 50% premix feed concentrate composition is prepared by adding:
soybean meal—17%,
canola meal—6.38%,
whole soybean—8%,
fishmeal—4%,
fat powder—3%,
sodium bicarbonate—1.3%,
salt—0.5%,
magnesium oxide—0.3%,
calcium carbonate—1.4%,
di calcium phosphate—0.5%,
toxin binder—0.2%,
monensin—0.02%,
vitamin supplements—0.7%, and
minerals supplements—0.7%.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 is a flow chart showing the steps involved in the method of synthesizing the ready-mixed feed concentrate, according to an embodiment herein.

### DETAILED DESCRIPTION OF THE EMBODIMENTS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a method for preparing feed concentrate in a more effective manner. The method of preparing a feed concentrate involves least manual errors and material wastage. The embodiments herein provide a method of preparing a feed concentrate ration wherein the raw materials are mixed and a standard composition is prepared. The standard composition is further added with various micronutrients depending on the requirements of the feed.

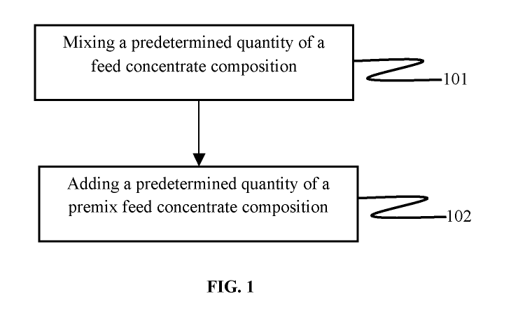

FIG. 1 is a flow chart showing the steps involved in the method of synthesizing the ready-mixed feed concentrate, according to an embodiment herein. With respect to FIG. 1, the method of preparing a ready-mix compound feed concentrate comprises mixing a predetermined quantity of a feed concentrate composition (101), and adding a predetermined quantity of a premix feed concentrate composition (102). The predetermined quantity of a premix feed concentrate composition is selected from the group consisting of 5%, 10%, 15%, 20%, 25% and 50%.

According to an embodiment herein, the ready-mix compound feed concentrate comprising 5% premix feed concentrate composition is prepared by adding 25% of barley—25%, 28.8% of corn, 17.4% of soybean meal, 6.38% of canola meal, 8% of whole soybean, 4% of fishmeal, fishmeal—4%, 3% of fat powder, 1.3% of sodium bicarbonate, and —0.5% of salt. The 5% premix feed concentrate composition is prepared by adding 0.3% of magnesium oxide, 1.4% of calcium carbonate, 0.5% of di calcium phosphate, 0.2% of toxin binder, 0.02% of monensin, 0.7% of vitamin supplements and 0.7% of minerals supplements.

According to an embodiment herein, the ready-mix compound feed concentrate comprising 10% premix feed concentrate composition is prepared by adding 25% of barley, 27% of corn, 16.72% of soybean meal, 6.38% of canola meal, 8% of whole soybean, 4% of fishmeal and 3% of fat powder. The 10% premix feed concentrate composition is prepared by adding 1.3% of sodium bicarbonate, 0.5% of salt, 0.3% of magnesium oxide, 1.4% of calcium carbonate, 0.5% of dicalcium phosphate, 0.2% of toxin binder, 0.02% of monensin, 0.7% of vitamin supplements and 0.7% of minerals supplements.

According to an embodiment herein, the ready-mix compound feed concentrate comprising 15% premix feed concentrate composition is prepared by adding 25% of barley, 26.1% of corn, 16.3% of soybean meal, 6.38% of canola meal, 8% of whole soybean and 4% of fishmeal. The ready-mix compound feed concentrate comprising 15% premix feed concentrate composition is prepared by adding 3% of fat powder, 1.3% of sodium bicarbonate, 0.5% of salt, 0.3% of magnesium oxide, 1.4% calcium carbonate, 0.5% of di calcium phosphate, 0.2% of toxin binder, 0.7% of vitamin supplements and 0.7% of minerals supplements.

According to an embodiment herein, the ready-mix compound feed concentrate comprising 20% premix feed concentrate composition is prepared by adding 25% of barley, 25.4% of corn, 16% of soybean meal, 6.38% of canola meal, 8% of whole soybean. The 20% premix feed concentrate composition prepared by adding 4% of fishmeal, 3% of fat powder, 1.3% of sodium bicarbonate, 0.5% of salt, 0.3% of magnesium oxide, 1.4% of calcium carbonate, 0.5% of di calcium phosphate, 0.2% of toxin binder and 0.02% of monensin, 0.7% of vitamin supplements and 0.7% of mineral supplements.

According to an embodiment herein, the ready-mix compound feed concentrate comprising 25% premix feed concentrate composition is prepared by adding 25% of barley, 27.5% of corn, 17% of soybean meal, and 6.38% of canola meal while the 25% premix feed concentrate composition is prepared by adding 8% of whole soybean, 4% of fishmeal, 3% of fat powder, 1.3% of sodium bicarbonate, 0.5% of salt, 0.3% of magnesium oxide, 1.4% of calcium carbonate, 0.5% of di calcium phosphate, 0.2% of toxin binder and 0.02% of monensin, 0.7% of vitamin supplements and 0.7% of mineral supplements.

According to an embodiment herein, the ready-mix compound feed concentrate comprising 50% premix feed concentrate composition is prepared by adding 25% of barley and 25% of corn while the 50% premix feed concentrate composition is prepared by adding 17% of soybean meal, 6.38% of canola meal, 8% of whole soybean, 4% of fishmeal, 3% of fat powder, 1.3% of sodium bicarbonate, 0.5% of salt, 0.3% of magnesium oxide, 1.4% of calcium carbonate, 0.5% of di calcium phosphate, 0.2% of toxin binder and 0.02% of monensin, 0.7% of vitamin supplements and 0.7% of mineral supplements.

According to an embodiment herein, a production method is provided comprising different kinds of ready-mixed compound feed concentrates up to a measure of 50 percent capable of quality enhancement and exact control of animal complete feeds improvement of economic and productive performance.

According to an embodiment herein, the ready-mixed compound feed concentrates composition comprises minerals and vitamin supplements. The level use of vitamins than other nutrients in the ration is very low, but the rate must be provided through appropriate resources to meet the needs of the body. The vitamin supplements containing fat-soluble vitamins (A, D3, E, k) and water-soluble vitamins (C, B complex) helps in improvement of the performance and prevention of the disease. The minerals in the skeletal structure and composition of animal products (milk, meat, etc.) play an important role in the functioning of the body wherein the lack of these minerals leads to decreased growth and production. The mineral supplement used contains all the minerals needed (micronutrients and macronutrients), including calcium, phosphorus, sodium, chloride, magnesium, potassium, iron, copper, zinc, iodine, sulphur, selenium, chromium, cobalt and manganese in the form of organic and chelates mineral that provides high absorption and availability and increases the shelf life of certain thinners that are formulated with antioxidant compounds.

According to an embodiment herein, the ready-mixed compound feed concentrates composition comprises sources of protein and energy. The protein helps in formation of muscle, growth and livestock production and reproduction. The protein sources which we used in premix invention including vegetable protein sources such as soybean meal, soybeans, rapeseed meal and animal protein sources such as fish meal. The carbohydrate or energy supplies are the most important nutrients needed by the body. The carbohydrate sources are milk, meat, energy storage and other daily activities. The premix invention is provided comprises carbohydrates sources in the form of barley and maize/corn and also in the form of fat powder.

According to an embodiment herein, the ready-mixed compound feed concentrates composition comprises additives. The recommended additives are mixed with salt (NaCl), sodium bicarbonate, calcium carbonate, magnesium oxide, di-calcium phosphate, monensin and toxin binder.

According to an embodiment herein, the grain source comprises the ground barley and ground corn, the protein sources comprises soybean meal, rapeseed meal, extruded soybeans, cotton seeds, corn gluten mean and the fish meal. The fat sources comprise the protected fat meal. The micronutrient comprises sodium bicarbonate, magnesium oxide, calcium carbonate, di calcium phosphate, salt and vitamin and mineral supplements. According to an embodiment herein, the ready-mix compound feed concentrates composition comprises volumizers or carriers. The carriers comprise barley and wheat bran. The present invention comprises proportions of nutritive, therapeutic, mineral, and vitamin supplements ranging from measures of 0 to 10 percent; energy and protein sources ranging from 0 to 50 percent; and recommended additives ranging from measures of 0 to 20 percent. The carriers are added so that the final product reaches a measure of 100 percent.

According to the embodiments herein, the sources used to supply animal's mineral requirements according to an embodiment herein include chemical compounds with a feed grade and organic compounds chelated with minerals to provide macro elements such as calcium, phosphorus, sodium, potassium, magnesium, sulphur, chlorine, and micro elements including zinc, manganese, iodine, copper, selenium, cobalt, and iron. The raw materials that supply above elements are: carbonate calcium as the source of calcium; mono- and di-calcium phosphates as the source of phosphorus; salt as the source of sodium and chlorine; oyster shell and bone meal as sources of calcium, phosphorus, and magnesium; zinc oxide and sulphate as the source of zinc; selenite sodium as the source of selenium; iron sulphate as the source of iron; copper sulphate as the source of copper; manganese oxide and sulphate as the source of manganese; iodate potassium and calcium as the source of iodine and potassium; and cobalt sulphate as the source of cobalt.

The above compounds are formulated from feed sources based on their purity percentages and bioavailability to animal. It should be noted that these sources are examined and analysed to ensure they contain the minimum allowable heavy and poisonous metals also from organic compounds such as organic zinc, organic copper, organic manganese, organic selenium, organic cobalt and organic chromium will be used in formulation of mineral premix.

According to the embodiments herein, the vitamin-containing materials are supplied from pure vitamin sources that involve atleast two groups of fat-soluble vitamins including A, D₃, E and K and water-soluble vitamins including vitamin C and Vitamin B such as Thiamin, Riboflavin, Pyridoxin, Folic acid, Panthotenic acid, Cyanocobalamin, Niacin, Biotin, and Choline. The two groups meet the needs of animal. In selecting the vitamins, quality is of great importance which is judged on the basis of the country producing the product as well as the validity of the manufacturer's certificates such as FAMIQS, GMP, and ISO certificates. Using these measures, the purity percentage for any demand in the different aging and productive groups can be determined and used in the invented premix concentrates.

According to the embodiments herein, the energy and protein sources with desirable quality and suitable process are used in different productive groups in premixes of up to 50% concentrates.

According to the embodiments herein, the sources involve other special feed materials including extruded oil seed such as flaxseed and heated oil seeds such as soybean until the lost anti nutritional factors.

According to the embodiments herein, the protein rich sources mentioned include oil seed meal of such as soybean meal, canola meal, cotton seed meal and sunflower meal as well as animal proteins such as fish meal and meat meal and other protein sources such as non-protein nitrogen compounds that will provide premixes of up to 50% concentrates.

According to an embodiment herein, the proposed premixed concentrate is increased to a 50% concentrate by adding other feed sources such as dietary bypass fat sources. The dietary bypass fat sources including saturated fat powder and saponified fat powder are used as energy sources needed in sensitive cattle such as high production animals, during hot seasons.

According to the embodiments herein, the recommended additives required in animal feeds are classified based on their specific functions as follows: a) those that adjust ruminal pH including buffer materials and alkalizers like sodium bicarbonate and magnesium oxide. The use of these additives is inevitable, especially in warm seasons of the year, for high producing lactating dairy cows that consume high level of concentrate in the ration, high level of corn silage in the ration, consumption of feeds separately and sudden changes in the ration.

b) Those adjusting the cation-anion balance in the ration including such compounds as magnesium sulphate, calcium chloride, ammonium chloride, calcium sulphate as anion making materials during the close up period, and those compounds such as sodium bicarbonate and potassium bicarbonate as cation making resources during the peak production period. These must be especially used in the warm seasons of the year. It should be noted that, in addition to the above direct effects, these nutrients also provide part of the body nutrient requirements, which are duly considered in balancing the animal ration.

c) Those controlling metabolic disorders during the transfer period. These materials include materials that supply or are precursors to glucose such as glycol propylene, calcium propionate, and glycerol as well as those adjusting liver function such as niacin, 1-carnitine, choline, biotin, and organic chrome, which also play important roles in reducing metabolic disorders such as the milk fever, ketosis, and the fatty liver.

d) Ionophers compounds (lipophilic compounds that alter intracellular ionic charge germs and pathogens are causing death) through reducing the growth of Gram-positive bacteria, help reduce methane production and increase the propionate to acetate ratio and the bypass protein in the rumen. These include monensin and lasalocid.

e) Probiotic compounds (live microorganisms which when administered in adequate amounts and in certain favourable effects on the host will have to follow), prebiotic (non-digestible feed ingredients that have beneficial effects on the health of the host), symbiotic (a combination of prebiotic and probiotic) along with yeasts that, through changing the microbial flora in the intestine, give rise to improved digestibility of ruminal fibre and increased microbial protein absorption.

f) Antioxidant compounds such as carotenoids and herbal essential oils that, by maintaining the anaerobic system sustainable, not only enhance feed palatability and fragrance but, with the help of selenium compounds and vitamin E, also play an important role in metabolism and in strengthening the immunity system. These essential oils also have a performance similar to the ionophore compounds and oral antibiotics, which help reduce methane and nitrogen releases which, in turn, lead to enhanced efficiency of energy and protein productivity in the rumen.

g) Bypass amino acid sources such as protected lysine and methionine and supply the deficient amino acids required for the body.

h) Toxin binders compounds, in single- or multi-component forms, serve as the binder of mycotoxins and toxins.

i) Flavours that improves the taste of feed (such as recommended feed essence).

j) growth stimulants (such as rumen-protected choline).

k) Anti-fungal, prevent mold growth and toxin binding material.

l) enzymes and substances that improve the digestibility of nutrients (such as cellulase enzymes).

m) Pharmaceuticals such as anti-flatulence and for control of odour and insects.

According to the embodiments herein, the volumizers (carriers) are the materials used in different breeding and producing activities and in formulations based on real animal requirements. The carries include grains and protein sources such as corn, soyabean meal, canola, wheat, etc. which serve to increase the feed volume (in order to yield a homogeneous and uniform distribution) upon accurate weight measurements to be mixed in proper proportions in various animal premixed rations. The carriers used in animal feeds, in general, and in the proposed premix concentrate, in particular, serve two functions:

1) As the supplement to supply the deficient nutrients (e.g., corn, soyabean meal, canola meal)

2) As the volumizers and thinners to enhance product homogeneity and uniformity.

The invention described is entitled as “An Innovative Premix’ is readily available for the efficient feeding of animals due to its variable percentage mixes which are based on real nutritional requirements of animal. They are supplied simply and efficiently for the farmers (for instance, a given quantity of 100 kg of the premix in a one-ton 10% compound concentrate) in 25-kg bags commonly used for industrial applications

To use the premixes, it is sufficient to identify the target group based on all animal production parameters involved. These parameters and the farmers or factories demands are used to formulate premixes of up to 50% that are readily used in mixers to obtain the final animal feeds

### EXPERIMENTAL DATA

The proportions of the mixes are determined based on the latest research findings and with the help of precise tools such as different computer software packages. The concentrates thus prepared provide for a range of animal needs for micronutrients from a minimum of 10% that covers the basic micronutrient requirements to a maximum of 50% which supplies part of the protein and energy requirements in addition to the basic needs.

Given the fact that the majority of micronutrients, especially minerals, come in a variety of forms and from different sources, their purity level varies with the percent quantity of the effective element contained. For example, calcium carbonate is used as a source of calcium in the ration for dairy cows. The calcium content of this source usually varies from 30 to 40 percent. For this minimum calcium content of 30%, the purity of the whole compound will be 76.5%. If, however, more reliable sources with a calcium content of 39% become available for use, the purity of calcium carbonate will rise by up to 98%. The farmer is partly paying for impurities or unwanted materials, which is obviously a waste of money; and 2) the 23.5% of impurities in the compound purchased might include detrimental elements such as lead, cadmium, mercury and arsenic. The same argument holds for zinc oxide which supplies Zn in the ration. The compound comes in a variety of purity levels. In its pure form, the atomic mass of Zn is 84 and that of oxygen is 16. In most cases, however, the Zinc oxide extracted from ores contains 70 to 75% Zn, which accounts for a zinc purity of 80 to 85% of the total ore extracted. However, if the source used by the farmer contains only 42% Zn, the purity of the zinc oxide (ZnO) in the compound will then decline to 50%, that means the animal's requirement is met by only about 50 percent. This is while the remaining 50% might contain hazardous elements such as heavy metals that have detrimental effects on dairy production and reproduction. As a last example, the compound Di-calcium phosphate commonly used in the animal ration as a source of phosphorus contains in its normal state of a desirable quality about 17 to 19% phosphorous. However, analyses have shown cases with a phosphorous content of only 14% or even lower, which indicates a maximum of 60 to 65% of the value recommended in the relevant standards; this purity level is evidently far from the animal's requirements. The cases of compounds with low purity levels are not few and all provide evidence that the animal's needs may not be supplied in certain periods so that they might be undernourished, which will ultimately lead to declining production and reproduction with adverse economic consequences. Compounds with varying purity levels may fail to supply the nutritional needs of animals as they are made commercially available under identical formulations.

Sepahan Daneh Co. has at its disposal the most modern equipment and employs the latest lab techniques for determining the purity level and for performing biochemical analyses of feeds. Hiring experienced and highly qualified academic teams, the Company maintains access to the newest research findings and documents and exploits them toward optimization of feed formulations and also made at this company of the most modern weighing and mixing technologies to minimize labour errors in developing accurate and reliable feed premixes up to a measure of 50% that can be used for preparing complete feed concentrates in the easiest manner possible. The feeds thus prepared will ensure that all the animal's nutrient requirements are met. This is achieved by identifying the target group in terms of the growth stage, production level, seasonal changes, the facilities operational at the farm or plant, and the genetic potentials of the herd. The 50% premixed compound concentrates are produced in this Company for easy feed into feed-makers operating at the plant or farm.

Having one of the most well-equipped, on-site, laboratories, SepahanDaneh Co. is capable of running the periodic analyses and highly accurate laboratory tests with reliable results. Table 1 below shows the sample tests of purity percentages (of effective elements) for raw ingredients in December, 2013.

Table 1 showing sample tests of purity percentage of micronutrients

| Sample of | Ferrous | Manganese | Zinc | Copper |
|---|---|---|---|---|
| raw materials | Sulphate | oxide | oxide | sulphate |
| procured | (ferrous) | (manganese) | (zinc) | (copper) |
| Week 1 | 20.9 | 21.8 | 65.1 | 27 |
| Week 2 | 21 | 20.9 | 74 | 23.1 |
| Week 3 | 24.1 | 18.4 | 42.7 | 23.6 |
| Week 4 | 25 | 16.6 | 68 | 23 |
| Mean | 22.75 | 19.43 | 61.57 | 24.18 |
| Standard | 2.11 | 2.37 | 16.61 | 1.9 |
| Errors | | | | |

The farmers or feed concentrate manufacturing plants may easily add additional materials to the premix in order to prepare their required concentrates in a most efficient and easy manner for direct consumption by the target group. Thus, in formulating a ration to be used for preparing feed concentrates in the premixed method, provisions are made for the formulation and mixing of micronutrients and major elements in the ration in one concentrate according to the relevant standards with due regard to the purity levels of the raw ingredients used and in accordance with animal feed requirements in a manner that the least errors (P<0.05) occur in all the production steps. The premix is ready for use after other ingredients required in the concentrate (barley, corn, etc.) are added in the mixer to obtain the desired percentages. This provides a range of ready mixed feed concentrates with varying percentage measures as shown in Table 2 below so that in cases where certain ingredients are needed (assigned a value of zero in the Table), the concentrate with a relevant percentage measure can be used.

Table 2 showing the pre-mix feed concentrate composition

| | Concentrate composition (%) | | | | | | |
|---|---|---|---|---|---|---|---|
| | | Innovative | Innovative | Innovative | Innovative | Innovative | Innovative |
| | Traditional | premix | premix | premix | premix | premix | premix |
| | concentrate | (5%) | (10%) | (15%) | (20%) | (25%) | (50%) |
| Barley | 25 | 25 | 25 | 25 | 25 | 25 | 25 |
| Corn | 30 | 28.8 | 27 | 26.1 | 25.4 | 27.5 | 25 |
| Soybean meal | 18 | 17.4 | 16.72 | 16.3 | 16 | 17 | 0 |
| Canola meal | 6.38 | 6.38 | 6.38 | 6.38 | 6.38 | 6.38 | 0 |
| Whole Soybean | 8 | 8 | 8 | 8 | 8 | 0 | 0 |
| Fishmeal | 4 | 4 | 4 | 4 | 0 | 0 | 0 |
| Fat powder | 3 | 3 | 3 | 0 | 0 | 0 | 0 |
| Sodium Bicarbonate | 1.3 | 1.3 | 0 | 0 | 0 | 0 | 0 |
| Salt | 0.5 | 0.5 | 0 | 0 | 0 | 0 | 0 |
| Magnesium Oxide | 0.3 | 0 | 0 | 0 | 0 | 0 | 0 |
| Calcium carbonate | 1.4 | 0 | 0 | 0 | 0 | 0 | 0 |
| Di calcium phosphate | 0.5 | 0 | 0 | 0 | 0 | 0 | 0 |
| Toxin binder | 0.2 | 0 | 0 | 0 | 0 | 0 | 0 |
| Monensin | 0.02 | 0 | 0 | 0 | 0 | 0 | 0 |
| Vitamin supplements* | 0.7 | 0 | 0 | 0 | 0 | 0 | 0 |
| Mineral supplements* | 0.7 | 0 | 0 | 0 | 0 | 0 | 0 |
| Innovative premix* | 0 | 5 | 10 | 15 | 20 | 25 | 50 |
| Total (100%) | 100 | 100 | 100 | 100 | 100 | 100 | 100 |

With respect to Table 2, extra vitamin mineral supplements (Extra) source of vitamins required by animals (fat-soluble vitamins (A, D3, E, k) and water-soluble vitamins (C, B complex)) and a source of minerals, including all minerals needed (micronutrients and macronutrients), including calcium, phosphorus, sodium, chloride, magnesium, potassium, iron, copper, zinc, iodine, sulphur, selenium, chromium, cobalt, manganese and mineral chelating form is the availability (absorption) high and to increase the shelf life of certain thinners are formulated with antioxidant compounds.

The use of the premix invention depending on various conditions of production, level of production, breeds climate and weather combined at least 6 premix formulations having 5, 10, 15, 20, 25 and 50% is classified and prepared. The choice of using any of a variety of pre-mixture depends on the decision of the farm livestock management as well as the facilities available.

The innovative aspect of the premix invention involves the use of proper proportions of the above-mentioned ingredients in accordance with the latest formulated feed requirement Tables. The feed measurement tables are formulated keeping by using accurate measurements of material purity, and lab analysis of the raw feed sources are carried out in the laboratories at Sepahan Daneh Company.

The manufacturing procedure according to the present invention for 50% premix is based on accurate weight measurement and using microdosing and micromixing systems taking advantage of the latest technologies to minimize labour errors in producing 100% compound concentrates for the different stages of animal growth and animal production which can be usable in a variety of applications in farm or industrial situations.

The present invention provides a proper supply of the animal nutritional needs and avoids unwanted changes in the animal ration and its components and elements. The present invention avoids inclusion of detrimental impurities in the animal ration. The present invention provides improved animal production performance and increased milk production, improved reproduction performance and increased calving percentage in the herd preventing nutritional and metabolic disorders. The present invention helps in avoiding personal and biased preferences in feed premixes, especially with regard to trace ingredients, as well as enhancing homogeneity and balance in the premixes avoiding labour and measurement errors in the case of low dosage ingredients. The present invention decreases material losses and wastes by 3 to 5% and preventing wastage during storage, avoids unnecessary transportation costs for low dosage raw materials, reduces storage costs of micronutrients and increase profit of farmer. The present invention helps in reducing cull rates and emergency animal sales whereby longevity of animals in the herd and restores farmers' trust in the quality of main ingredients (grains and oil seed meal) used in the premix. The present invention intends to avoid any biased personal decisions, to determine the most proper proportions of all the major raw materials included in the proposed feed concentrates, and to provide a steady and uniform concentrate that is practically free from labour errors.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

I claim:

1. A ready-mixed compound feed concentrate, comprising:
a feed concentrate composition; and
a premix feed concentrate composition, wherein said premix feed concentrate composition is present in an amount selected from the group consisting of 5%, 10%, 15%, 20%, 25% and 50%.

2. The ready-mixed compound feed concentrate according to claim 1, wherein said ready-mixed compound feed concentrate comprises:
a feed concentrate composition; and
a 5% premix feed concentrate composition,
wherein said feed concentrate composition comprises:
barley—25%,
corn—28.8%,
soybean meal—17.4%,
canola meal—6.38%,
whole soybean—8%,
fishmeal—4%,
fat powder—3%,
sodium bicarbonate—1.3%, and
salt—0.5%;
wherein said 5% premix feed concentrate composition comprises:
magnesium oxide—0.3%,
calcium carbonate—1.4%,
di calcium phosphate—0.5%,
toxin binder—0.2%,
monensin—0.02%,
vitamin supplements—0.7%, and
minerals supplements—0.7%.

3. The ready-mixed compound feed concentrate according to claim 1, wherein said ready-mixed compound feed concentrate comprises:
a feed concentrate composition; and
a 10% premix feed concentrate composition,
wherein said feed concentrate composition comprises:
barley—25%,
corn—27%,
soybean meal—16.72%,
canola meal—6.38%,
whole soybean—8%,
fishmeal—4%, and
fat powder—3%;
wherein said 10% premix feed concentrate composition comprises:
sodium bicarbonate—1.3%,
salt—0.5%
magnesium oxide—0.3%,
calcium carbonate—1.4%,
di calcium phosphate—0.5%,
toxin binder—0.2%,
monensin—0.02%,
vitamin supplements—0.7%, and
minerals supplements—0.7%.

4. The ready-mixed compound feed concentrate according to claim 1, wherein said ready-mixed compound feed concentrate comprises:
a feed concentrate composition; and
a 15% premix feed concentrate composition,
wherein said feed concentrate composition comprises:
barley—25%,
corn—26.1%,
soybean meal—16.3%,
canola meal—6.38%,
whole soybean—8%, and
fishmeal—4%;
wherein said 15% premix feed concentrate composition comprises:
fat powder—3%
sodium bicarbonate—1.3%,
salt—0.5%
magnesium oxide—0.3%,
calcium carbonate—1.4%,
di calcium phosphate—0.5%,
toxin binder—0.2%,
monensin—0.02%,
vitamin supplements—0.7%, and
minerals supplements—0.7%.

5. The ready-mixed compound feed concentrate according to claim 1, wherein said ready-mixed compound feed concentrate comprises:
a feed concentrate composition; and
a 20% premix feed concentrate composition,
wherein said feed concentrate composition comprises:
barley—25%,
corn—25.4%,
soybean meal—16%,
canola meal—6.38%,
whole soybean—8%; and
wherein said 20% premix feed concentrate composition comprises:
fishmeal—4%,
fat powder—3%,
sodium bicarbonate—1.3%,
salt—0.5%,
magnesium oxide—0.3%,
calcium carbonate—1.4%,
di calcium phosphate—0.5%,
toxin binder—0.2%,
monensin—0.02%,
vitamin supplements—0.7%, and
minerals supplements—0.7%.

6. The ready-mixed compound feed concentrate according to claim 1, wherein said ready-mixed compound feed concentrate comprises:
a feed concentrate composition; and
a 25% premix feed concentrate composition,
wherein said feed concentrate composition comprises
barley—25%,
corn—27.5%,
soybean meal—17%,
canola meal—6.38%,
wherein said 25% premix feed concentrate composition comprises:
whole soybean—8%,
fishmeal—4%,
fat powder—3%,
sodium bicarbonate—1.3%,
salt—0.5%,
magnesium oxide—0.3%,
calcium carbonate—1.4%,
di calcium phosphate—0.5%,
toxin binder—0.2%,
monensin—0.02%,
vitamin supplements—0.7%, and
minerals supplements—0.7%.

7. The ready-mixed compound feed concentrate according to claim 1, wherein said ready-mixed compound feed concentrate comprises:
a feed concentrate composition; and
a 50% premix feed concentrate composition,
wherein said feed concentrate composition comprises:
barley—25%,
corn—25%,
wherein said 50% premix feed concentrate composition comprises:
soybean meal—17%,
canola meal—6.38%,
whole soybean—8%,
fishmeal—4%,
fat powder—3%,
sodium bicarbonate—1.3%,
salt—0.5%,
magnesium oxide—0.3%,
calcium carbonate—1.4%,
di calcium phosphate—0.5%,
toxin binder—0.2%,
monensin—0.02%,
vitamin supplements—0.7%, and
minerals supplements—0.7%.

8. A method of preparing a ready-mix compound feed concentrate, comprises:
mixing a predetermined quantity of a feed concentrate composition, and
adding a predetermined quantity of a premix feed concentrate composition, wherein said predetermined quantity of a premix feed concentrate composition is selected from the group consisting of 5%, 10%, 15%, 20%, 25% and 50%.

9. The method according to claim 8, wherein said ready-mix compound feed concentrate comprising 5% premix feed concentrate composition is prepared by adding:
barley—25%,
corn—28.8%,
soybean meal—17.4%,
canola meal—6.38%,
whole soybean—8%,
fishmeal—4%,
fat powder—3%,
sodium bicarbonate—1.3%, and
salt—0.5%;
wherein said 5% premix feed concentrate composition is prepared by adding:
magnesium oxide—0.3%,
calcium carbonate—1.4%,
di calcium phosphate—0.5%,
toxin binder—0.2%,
monensin—0.02%,
vitamin supplements—0.7%, and
minerals supplements—0.7%.

10. The method according to claim 8, wherein said ready-mix compound feed concentrate comprising 10% premix feed concentrate composition is prepared by adding:
barley—25%,
corn—27%,
soybean meal—16.72%,
canola meal—6.38%,
whole soybean—8%,
fishmeal—4%, and
fat powder—3%;
wherein said 10% premix feed concentrate composition is prepared by adding:
sodium bicarbonate—1.3%,
salt—0.5%
magnesium oxide—0.3%,
calcium carbonate—1.4%,
di calcium phosphate—0.5%,
toxin binder—0.2%,
monensin—0.02%,
vitamin supplements—0.7%, and
minerals supplements—0.7%.

11. The method according to claim 8, wherein said ready-mix compound feed concentrate comprising 15% premix feed concentrate composition is prepared by adding:
barley—25%,
corn—26.1%,
soybean meal—16.3%,
canola meal—6.38%,
whole soybean—8%, and
fishmeal—4%;
wherein said 15% premix feed concentrate composition is prepared by adding:
fat powder—3%
sodium bicarbonate—1.3%,
salt—0.5%
magnesium oxide—0.3%,
calcium carbonate—1.4%,
di calcium phosphate—0.5%,
toxin binder—0.2%,
monensin—0.02%,
vitamin supplements—0.7%, and
minerals supplements—0.7%.

12. The method according to claim 8, wherein said ready-mix compound feed concentrate comprising 20% premix feed concentrate composition is prepared by adding:
barley—25%,
corn—25.4%,
soybean meal—16%,
canola meal—6.38%,
whole soybean—8%; and
wherein said 20% premix feed concentrate composition is prepared by adding:
fishmeal—4%,
fat powder—3%,
sodium bicarbonate—1.3%,
salt—0.5%,
magnesium oxide—0.3%,
calcium carbonate—1.4%,
di calcium phosphate—0.5%,
toxin binder—0.2%,
monensin—0.02%,
vitamin supplements—0.7%, and
minerals supplements—0.7%.

13. The method according to claim 8, wherein said ready-mix compound feed concentrate comprising 25% premix feed concentrate composition is prepared by adding:
barley—25%,
corn—27.5%,
soybean meal—17%,
canola meal—6.38%,
wherein said 25% premix feed concentrate composition is prepared by adding:
whole soybean—8%,
fishmeal—4%,
fat powder—3%,
sodium bicarbonate—1.3%,
salt—0.5%,
magnesium oxide—0.3%,
calcium carbonate—1.4%,
di calcium phosphate—0.5%,
toxin binder—0.2%,
monensin—0.02%,
vitamin supplements—0.7%, and
minerals supplements—0.7%.

14. The method according to claim 8, wherein said ready-mix compound feed concentrate comprising 50% premix feed concentrate composition is prepared by adding:
barley—25%,
corn—25%,
wherein said 50% premix feed concentrate composition is prepared by adding:
soybean meal—17%,
canola meal—6.38%,
whole soybean—8%,
fishmeal—4%,
fat powder—3%,
sodium bicarbonate—1.3%,
salt—0.5%,
magnesium oxide—0.3%,
calcium carbonate—1.4%,
di calcium phosphate—0.5%,
toxin binder—0.2%,
monensin—0.02%,
vitamin supplements—0.7%, and
minerals supplements—0.7%.
